(19) United States
(12) Patent Application Publication
(10) Pub. No.: US 2012/0019359 A1
(43) Pub. Date: Jan. 26, 2012

(54) VEHICLE SECURITY SYSTEM AND METHOD OF USING THE SAME

(75) Inventor: CHIEN-LIH LUNG, Tu-Cheng (TW)

(73) Assignee: HON HAI PRECISION INDUSTRY CO., LTD., Tu-Cheng (TW)

(21) Appl. No.: 13/009,027

(22) Filed: Jan. 19, 2011

(30) Foreign Application Priority Data
Jul. 20, 2010 (TW) 99123727

(51) Int. Cl. G06F 7/04

(52) U.S. Cl. 340/5.72; 340/5.83

(57) ABSTRACT

A vehicle security system includes a trigger module, an image acquisition module, a microprocessor and a database. The trigger module triggers the image acquisition module to capture a pupil image of a proximal party triggering the trigger module. The database is coupled with the microprocessor and stores at least one pupil image of an authorized user. The microprocessor includes a comparison module and a response module. The comparison module compares the pupil image captured by the image acquisition module with the stored pupil image in the database and generates a result notification to the response module. The response module implements an appropriate responsive action to lock or unlock the vehicle according to the determination. The disclosure further provides a method for vehicle security.

### BACKGROUND

1. Technical Field

The present disclosure generally relates to security systems, and more particularly to a system providing vehicle security and a method of using the same.

2. Description of Related Art

To address the problems of automobile theft, devices have been developed that physically secure a vehicle against theft, such as, for example, steering wheel locks, however these devices are inconvenient to use. Placement and removal of these devices are required at every stop to realize their full benefit. Furthermore, such devices typically only deter the thief to a more opportune target, in which case the device can be quickly removed with a hacksaw or stolen key.

Therefore, there is room for improvement within the art.

### BRIEF DESCRIPTION OF THE DRAWINGS

The components in the drawings are not necessarily drawn to scale, the emphasis being placed upon clearly illustrating the principles of the present disclosure. Moreover, in the drawings, like reference numerals designate corresponding parts throughout several views, and all the views are schematic.

FIG. 1 is a block diagram of an embodiment of a vehicle security system.

FIG. 2 is a flowchart of a method of using the system of FIG. 1.

### DETAILED DESCRIPTION

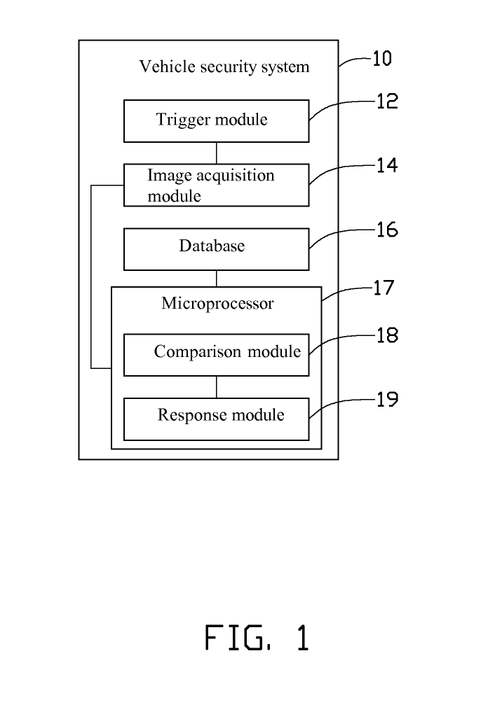

Referring to FIG. 1, a vehicle security system 10 includes a trigger module 12, an image acquisition module 14, a database 16 and a microprocessor 17. The database 16 is coupled with the microprocessor 17. The microprocessor 17 includes a comparison module 18 and a response module 19.

The trigger module 12 triggers the image acquisition module 14. In the illustrated embodiment, the trigger module 12 includes an induction device disposed on the handle of the vehicle door. When an attempt is made to open the vehicle door, the induction device registers the attempt and the trigger module 12 triggers the image acquisition module 14. It should be pointed out that the trigger module 12 may be an infrared induction device detecting for object proximity and notifying the trigger module 12 to trigger the image acquisition module 14.

The image acquisition module 14 includes a camera (not shown) and an illumination device (not shown). The image acquisition module 14 may be positioned in the vehicle. The camera is configured to capture at least one pupil image of the party triggering the trigger module 12. The illumination device supports the image acquisition module 14 under insufficient light. Brightness of the illumination device may change periodically to stimulate the pupil to shrink or dilate, such that a plurality of pupil images may be captured. The illumination device may be an infrared illumination device to capture more detailed texture of the pupil of a proximal party and protect the pupil from damage by the bright light emitted from the illuminating device. The image acquisition module 14 may further include a position adjusting device (not shown) on which the camera and the illumination device are fixed, such that the angle of the camera and the illumination device relative to the proximal party may be automatically adjusted according to the position and the height of the proximal party.

The database 16 is configured to store the pupil images of at least one authorized user, a plurality of which can be acquired using the image acquisition module 14.

The microprocessor 17 is coupled with a control system (not shown) of the vehicle to lock or unlock the vehicle.

The comparison module 18 compare the pupil images captured by the image acquisition module 14 with the stored pupil images in the database 16 by comparison therebetween, and generates a result notification to the response module 19. The output signal is the comparison result.

The response module 19, based on the comparison result generated by the comparison module 18, implements a corresponding responsive action for locking or unlocking the vehicle accordingly. In the illustrated embodiment, if the similarity between the captured pupil image and the at least one stored pupil image in the database 16 exceeds or equals a preset value, the response module 19 unlocks the vehicle. If the similarity between the captured pupil image and each pupil image stored in the database 16 is less than the preset value, the response module 19 locks the vehicle, and stores the captured pupil image for reference.

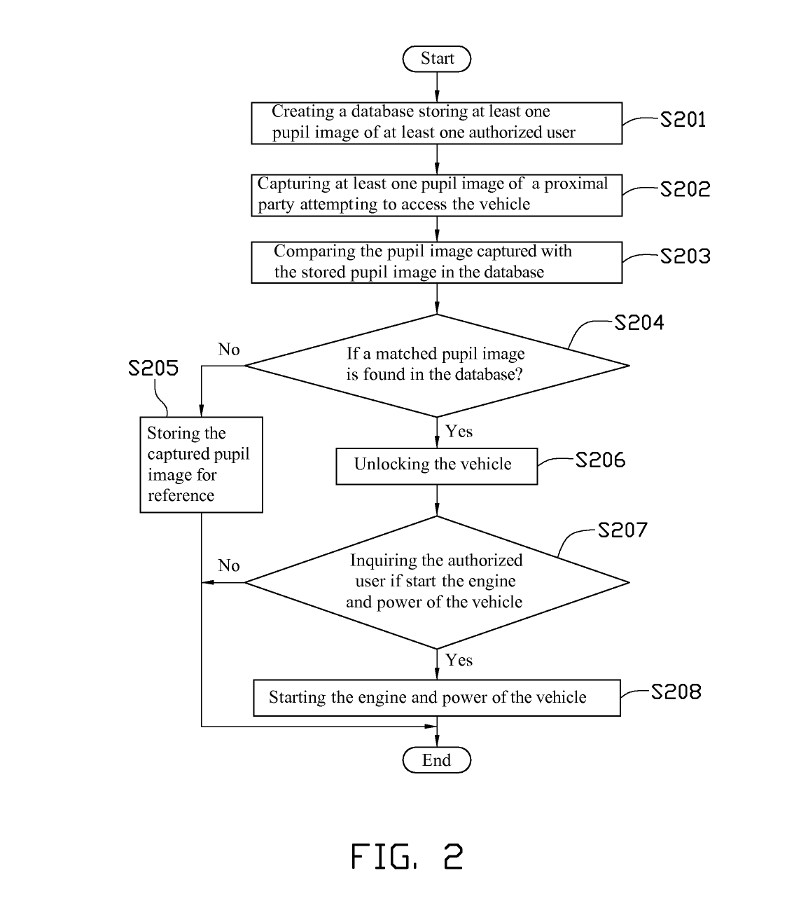

Referring to FIG. 2, a method for preventing vehicle theft using the vehicle security system shown in FIG. 1 is as follows.

In step S201, a database 16 is created, and configured to store at least one pupil image of at least one authorized user.

In step S202, at least one pupil image of a proximal party attempting to access the vehicle is captured. In the illustrated embodiment, the at least one pupil image is captured by an image acquisition module 14 triggered by a trigger module 12 when the proximal party approaches or makes contact with the vehicle.

In step S203, the captured pupil image of the proximal party is compared with each of the stored pupil images in the database 16. In the illustrated embodiment, the captured pupil image is compared with the stored pupil image in the database 16 by a comparison module 18 by calculating a similarity between the captured pupil image and each of the stored pupil images in the database 16.

In step S204, if the similarity between the captured pupil image and each pupil image stored in the database is less than a preset value, step S205 is then implemented. If the similarity between the captured pupil image and at least one stored pupil image in the database exceeds or equals the preset value, step S206 is implemented.

In step S205, the captured pupil image is stored for reference.

In step S206, the vehicle is unlocked.

In step S207, an authorized user receives a prompt to start the engine and the power of the vehicle. If the authorized user chooses yes, step S208 is implemented, otherwise, the method is complete and terminates.

In step S208, the engine and power system of the vehicle are started.

The vehicle security system 10 generates an appropriate decision to lock or unlock the vehicle by capturing a pupil image of a proximal party for comparison with the pupil images of authorized users, thereby securing the vehicle even if the key of the vehicle is stolen. Furthermore, the user need not carry the key, thereby enhancing convenience.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A vehicle security system, comprising:
a trigger module;
an image acquisition module, the image acquisition module is adapted to capture at least one pupil image of a proximal party triggering the trigger module;
a microprocessor comprising a comparison module and a response module; and
a database, the database is coupled with the microprocessor, wherein the trigger module triggers the image acquisition module, the database stores at least one pupil image of at least one authorized user, the comparison module compares the pupil image of the proximal party captured by the image acquisition module with the stored pupil image in the database and generate a result notification to the response module, the response module makes a determination as to whether or not the pupil image captured by the image acquisition module matches with the at least one pupil image stored in the database according to an output signal which is the comparison result, and generate an appropriate corresponding responsive action to lock or unlock the vehicle responding to the determination.

2. The vehicle security system of claim 1, wherein the trigger module comprises an infrared induction device.

3. The vehicle security system of claim 1, wherein the trigger module comprises an induction device disposed on the handle of the vehicle door.

4. The vehicle security system of claim 1, wherein the image acquisition module comprises a camera and an illumination device.

5. The vehicle security system of claim 4, wherein the illumination device is an infrared illumination device.

6. The vehicle security system of claim 4, wherein a brightness of the illumination device changes periodically.

7. The vehicle security system of claim 4, wherein the image acquisition module further comprises a position adjusting device on where the camera and the illumination device are fixed.

8. The vehicle security system of claim 1, wherein the comparison module compares the pupil image captured by the image acquisition module with the stored pupil image in the database by calculating a similarity between the captured pupil image and the stored pupil image in the database, and the output signal is the similarity calculated by the comparison module.

9. A method for vehicle security, comprising:
creating a database storing at least one pupil image of at least one authorized user;
capturing at least one pupil image of a proximal party attempting to open the door of the vehicle;
comparing the captured pupil image with the stored pupil image in the database;
determining if a matched pupil image is found in the database; and
unlocking the vehicle if the matched pupil image is found in the database.

10. The method of claim 9, wherein the step of determining if a matched pupil image is found in the database comprises:
determining the matched pupil image is found if the similarity between the captured pupil image and the at least one stored pupil image in the database exceeds or equals a preset value; and
determining no matched pupil image is found in the database if the similarity between the captured pupil image and each pupil image stored in the database is less than the preset value.

11. The method of claim 9, further comprising inquiring the authorized user whether to start the engine and the power system of the vehicle after the step of determining if a matched pupil image is found in the database.
